(19) United States
(12) Patent Application Publication
(10) Pub. No.: US 2012/0174315 A1
(43) Pub. Date: Jul. 12, 2012

(54) PORTABLE LIFT

(76) Inventor: Robert V. Gurinowitsch, Uniontown, OH (US)

(21) Appl. No.: 13/344,311

(22) Filed: Jan. 5, 2012

Related U.S. Application Data
(60) Provisional application No. 61/430,370, filed on Jan. 6, 2011.

(51) Int. Cl. A61G 7/10

(52) U.S. Cl. 5/83.1

(57) ABSTRACT

This invention relates to a portable lift device for moving bariatric patients. The portable lift includes a beam having a track which is sized to allow a trolley portion of a lift assembly to move therein. A bracket is removably secured at each end of the beam, whereby each bracket is configured to receive ends of two leg assemblies. Each of the four leg assemblies are individually adjustable along a longitudinal length, allowing the portable lift to conform to a multitude of surface types. Thus, a patient can be lifted by the lift assembly, moved along the beam and over a surface or obstacle by way of the trolley in the track, and deposited onto a gurney or stretcher for further movement. The portable lift is modular in nature, which allows a user to easily carry the lift in a disassembled state, and assemble the lift at any desired location.

### CROSS-REFERENCE TO RELATED APPLICATION

This application claims priority from U.S. Provisional Application Ser. No. 61/430,370, filed Jan. 6, 2011, the disclosure of which is incorporated herein by reference.

### BACKGROUND OF THE INVENTION

1. Technical Field

This invention relates to mechanical lift devices. More particularly, this invention relates to portable modular lift devices used to lift individuals. Specifically, this invention relates to a portable mechanical bariatric lift comprised of elements which are easily assembled to construct said lift at a desired location, and wherein the lift is easily configurable to transport patients over uneven surfaces.

2. Background Information

The increasing rate of obesity (34% of adults in 2004) poses increasing challenges for emergency medical personnel. Emergency medical services may need to provide transfer and care for patients weighing more than 500 pounds. Mobilizing the appropriate equipment and personnel through dispatch, utilizing special techniques and protocols, and maintaining patient dignity are necessary to provide safe, high-quality pre-hospital service to bariatric individuals.

While emergencies involving bariatric patients are fairly common, the number of injuries to the emergency response personnel responding to these calls is staggering. Often, department policies only allow two EMS workers or firefighters per emergency response, which necessarily only divides the amount of weight each individual is responsible for lifting in half. For example, a typical bariatric emergency would require two individuals to lift a 500 pound person out of bed and into a stretcher. This results in each EMS worker or firefighter lifting 250 pounds while bent in awkward positions to grasp the bariatric patient. This far exceeds the recommended 25 pound weight limit for on the job lifting recommended by OSHA. The resulting injuries to the response personnel often require months of medical leave for the injured individual, which in turn reduces staff for the EMS or firefighting unit.

Bariatric individuals are often in bedrooms or bathrooms on an upper floor of a house or apartment, and require transportation not only from the bed to the stretcher, but from one floor to another. Currently, EMS and fire departments use a combination of slings, ropes, winches, and dollies to transport bariatric patients over difficult or uneven surfaces such as steps. This dramatically increases the amount of time involved in getting a patient into the hospital, and represents an embarrassing situation to the patient.

Ambulances and stretchers, among other emergency response elements, all have weight limits which should not be surpassed during a bariatric response. However, often only a general idea of the true weight of the bariatric patient is known, yet time is of the essence during an emergency response and any extra steps to weigh the individual may put the patient in danger.

As such, there is a great need in the art for a bariatric emergency response tool which is portable and easy to assemble and disassemble at the scene of an emergency. This tool should be configurable to respond to a variety of surfaces such as steps, and should be light enough for one or two individuals to carry into an emergency situation. Each element of the disassembled tool should be designed to fit into a standard ambulance bay or fire response vehicle. The tool should also include a scale or weighing device which is incorporated into the overall structure, so as to provide an accurate weight of the patient without any additional steps during the emergency response.

### BRIEF SUMMARY OF THE INVENTION

This invention relates to a portable bariatric lift which is comprised of elements which are easily assembled on site to construct and deconstruct the lift quickly during an emergency. The portable lift includes adjustable leg assemblies which may be individually configured to provide a stable bracing system for a track which guides a lift assembly carrying the bariatric patient. The disassembled lift may be transported and set up as desired by a single individual at the emergency location. The lift may also include a bariatric weight device incorporated into the lift, such that the patient can be weighed seamlessly during the lifting and emergency response without requiring any additional steps.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a side elevational view of the portable lift of the present invention in the fully assembled state;

FIG. 2 is an exploded view thereof;

FIG. 3 is a front elevational view of the portable lift in the fully assembled state;

FIG. 4 is a front elevational view of an angled bracket of the present invention;

FIG. 5 is a side elevational view thereof;

FIG. 6 is a bottom perspective view thereof;

FIG. 7 is an enlarged view of a leg assembly and foot bracket of the present invention;

FIG. 8 is an enlarged sectional view of a leg assembly having a cotter pin extended therethrough;

FIG. 9 is a sectional view taken along line 9-9 of FIG. 1;

FIG. 10 is a sectional view taken along line 10-10 of FIG. 9;

FIG. 11 is a side elevational view of a method of using the portable lift to move a patient from a bed to a stretcher;

FIG. 12 is a side elevational view of a method of using the portable lift to move a patient over a disruption in a surface; and

FIG. 13 is a side elevational view of a method of using the portable lift to provide rehabilitation services to a patient.

Similar numbers refer to similar parts throughout the drawings.

### DETAILED DESCRIPTION OF THE INVENTION

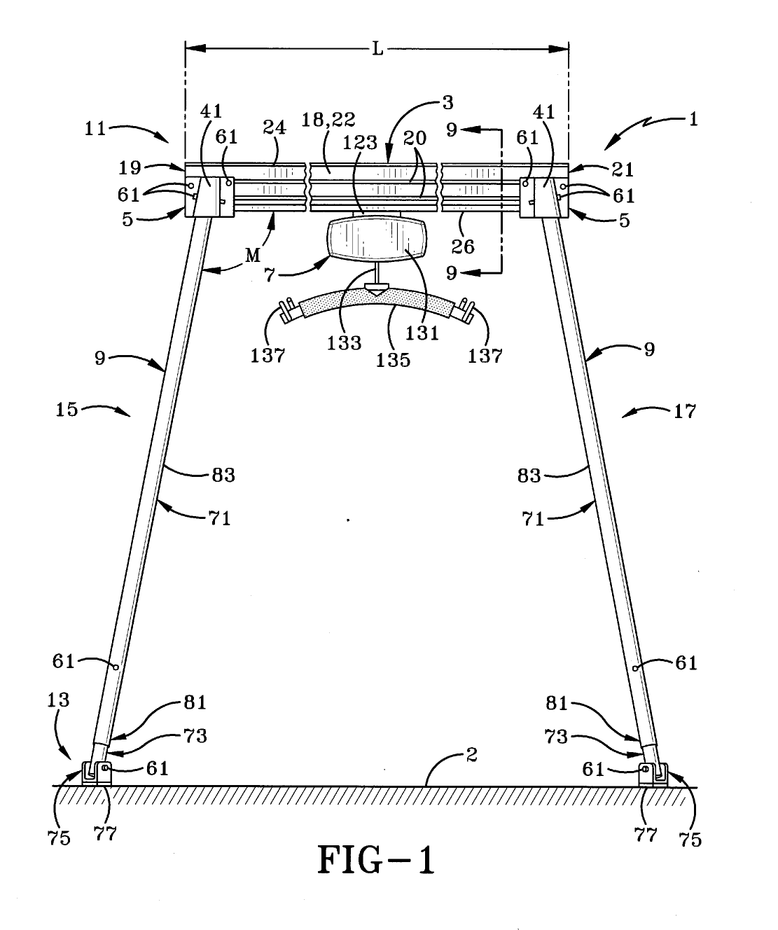

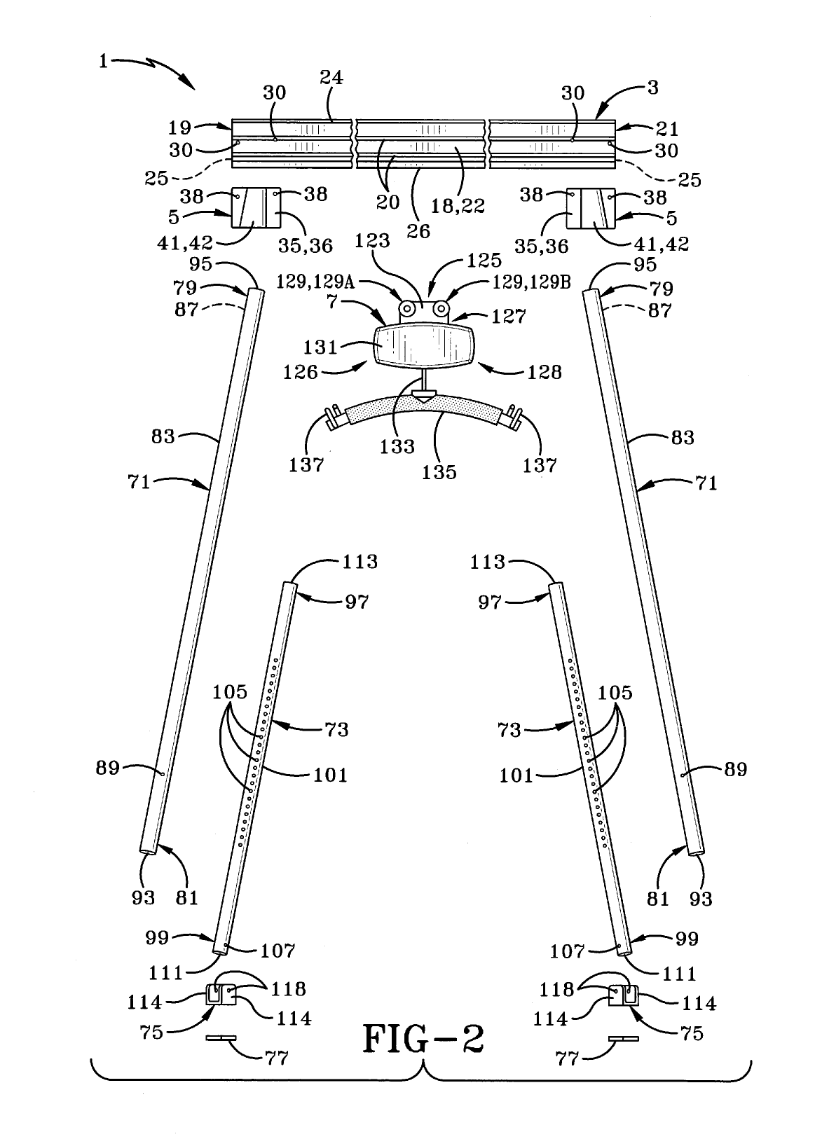

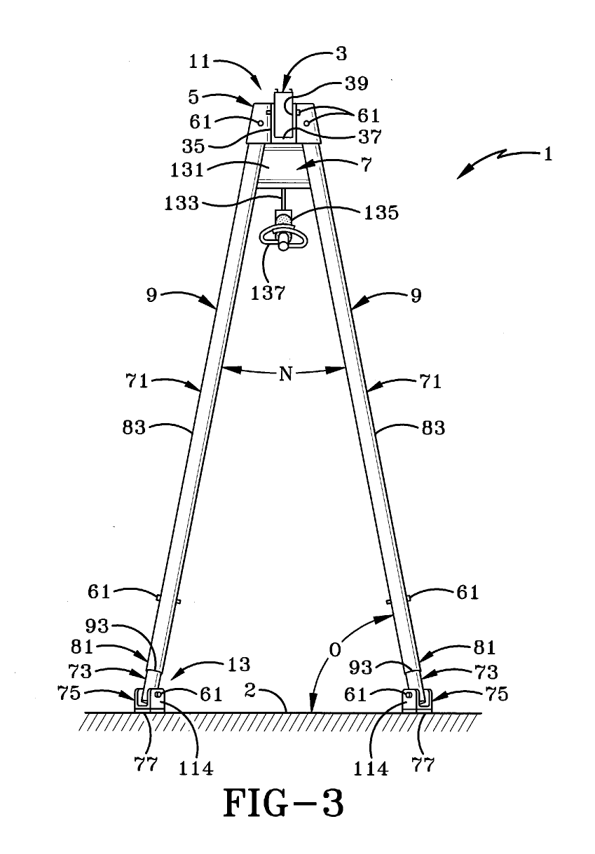

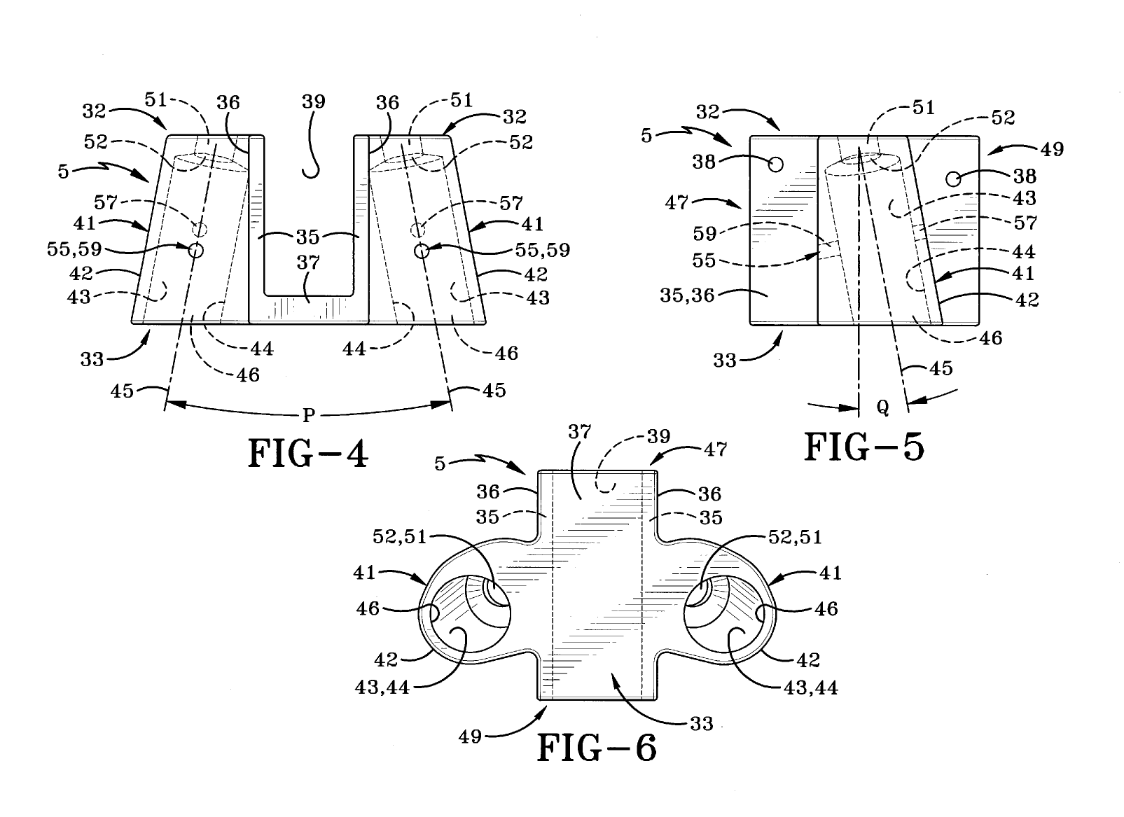

The portable lift of the present invention is shown in FIGS. 1-11 and is indicated generally at 1. As shown in FIGS. 1-3, portable lift 1 includes a beam 3, a pair of angled brackets 5, a lift assembly 7, and four leg assemblies 9. Portable lift 1 may exist in a fully assembled state (FIGS. 1 and 3) for resting on a surface 2, or a fully dissembled state (FIG. 2), or any intermediate state therebetween. Thus, it is a primary feature of the invention that a user may assemble and disassemble portable lift 1 as desired. In the fully assembled state, portable lift 1 includes an upper end 11, a lower end 13, a front end 15, and a back end 17.

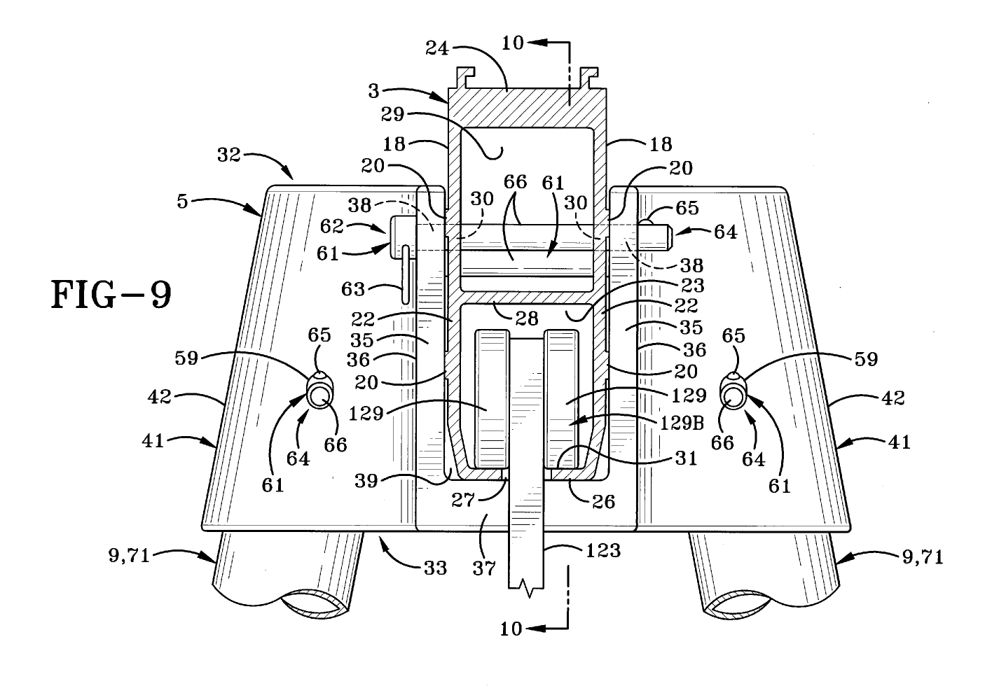

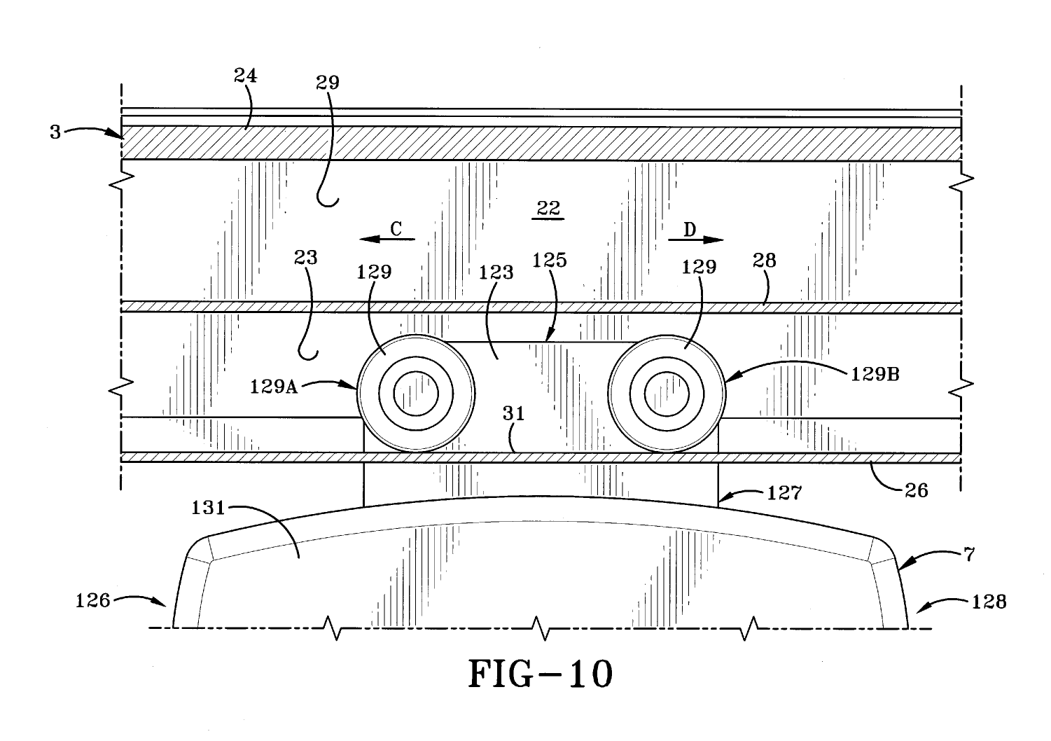

As shown in FIGS. 1, 2, 9, and 10, beam 3 is an elongated structure of length L having an outer surface 18 and extending from a first end 19 to a second end 21. Beam 3 includes a plurality of braces 20 extending from first end 19 to second end 21 on outer surface 18, a pair of sidewalls 22, an upper wall 24, a bottom wall 26 having a track surface 31, and an interior wall 28. As shown in FIG. 9, sidewalls 22 have a bottom portion 34 which tapers to meet bottom wall 26. Sidewalls 22, bottom wall 26, and interior wall 28 define a pair of spaced apart track openings 25 and a track 23 extending along the length of beam 3 between each track opening 25. Bottom wall 26 further defines a trolley seam 27 extending between each opening 25. Sidewalls 22, interior wall 28, and upper wall 24 define an upper channel 29 extending along the length of beam 3. Sidewalls 22 further define a plurality of channel apertures 30 extending between upper channel 29 and outer surface 18.

As shown in FIGS. 4-6, angled bracket 5 includes a top end 32, a bottom end 33, a front end 47, a rear end 49, and a pair of parallel sidewalls 35 extending from top end 32 to bottom end 33 and having an outer surface 36. Sidewalls 35 extend from a bottom wall 37, whereby a channel 39 is defined by sidewalls 35 and bottom wall 37. Each sidewall 35 defines a pair of pin holes 36 extending from outer surface 36 to channel 39. A leg receiver 41 having an exterior surface 42 extends outwardly from each sidewall 35 and defines a conical shaped leg recess 43 having a surface 44 therein and an opening 46 proximate bottom end 33. Proximate top end 32, leg receiver 41 further defines a conical air channel 51 having an opening 52. Each leg recess 43 is angled relative sidewalls 35 such that an imaginary line 45, taken along the longitudinal center of leg recess 43, is angled towards sidewall 35 and towards front end 47 proximate top end 32. A pin shaft 55 is further defined by leg receiver 41 and extends through leg recess 43 from a first opening 57 to a second opening 59.

Referring particularly to FIGS. 1 and 9, each angled bracket 5 in the pair is secured to one of the first end 19 and second end 21 of beam 3. Inasmuch as angled brackets 5 are identical, the same method of securing angled bracket 5 to beam 3 is used for each. As shown in FIG. 9, first end 19 of beam 3 is placed into channel 39 of angled bracket 5 whereby bottom wall 26 of beam 3 is resting upon bottom wall 37 of angled bracket 5. Bottom portion 34 of sidewalls 22 is angled inwardly towards bottom wall 26 to facilitate lowering bottom wall 26 into channel 39 from top end 32 towards bottom end 33. Once beam 3 is placed inside channel 39, sidewalls 35 are generally parallel to sidewalls 22, however, the plurality of braces 20 extending from first end 19 to second end 21 of beam 3 hold sidewalls 22 generally a spaced distance apart from sidewalls 35. When first end 19 of beam 3 is properly aligned in channel 39, each pin hole 36 in sidewalls 35 aligns with one of the plurality of channel apertures 30.

A plurality of interchangeable cotter pins 61 are used throughout portable lift 1 when a removable connection is required between two elements. Each cotter pin 61 includes a head end 62 with a pull ring 63, and a locking end 64 with a locking tab 65, and a shaft 66 extending therebetween. As such, one of the plurality of cotter pins 61 is inserted through angled bracket 5 and beam 3 to lock these two elements together. The same general method is used for all cotter pins 61 and pin holes 36 such that locking end 64 of one of the plurality of cotter pins 61 is inserted through a particular pin hole 36 in one of the sidewalls 35. Manual pressure is then applied to head end 62 to extend locking end 64 through a particular channel aperture 30 in a one of the sidewalls 22, through upper channel 29, through a particular channel aperture 30 in the other one of the sidewalls 22, and finally through a particular pin hole 36 in the other one of the sidewalls 35.

Locking tab 65 is a common feature used with the style of cotter pins shown as cotter pins 61, and it will be readily understood that locking tab 65 is movable and biased outwardly as the default state. As locking tab 65 passes through pin holes 36 and channel apertures 30, the bias is overcome and locking tab 65 depresses to allow locking end 64 to pass therethrough. When locking end 64 passes entirely through an aperture, locking tab 65 returns to the default state. Thus, cotter pins 61 are removably secured to angled brackets 5 and beam 3 by way of locking tab 65. It will also be readily understood in the art that cotter pins 61 represent one type of fastener that may be used to secure angled bracket 5 to beam 3, and any other similar fastener may be used in place thereof. Furthermore, cotter pins 61 are generally used throughout portable lift 1 to removably secure two elements together. It will be readily understood that using a standard removable fastener throughout portable lift 1 increases efficiency for which portable lift 1 can be assembled and disassembled, as any one of the plurality of cotter pins 61 can be used when a removable fastener is required. Conversely, while the preferred embodiment of portable lift 1 includes fasteners which all have the same size and shape (cotter pins 61), any number of different fasteners may be used, and any number of combinations of sizes and shapes may be used where a fastener is required.

As shown in FIGS. 2, 7, and 8, leg assembly 9 includes a tubular-shaped outer sleeve 71, a tubular-shaped inner sleeve 73, a foot bracket 75, and a bracket base 77. Outer sleeve 71 includes a top end 79, a bottom end 81, an outer surface 83, and an inner surface 85. Outer sleeve 71 defines a pair of upper pin holes 87, a pair of lower pin holes 89, a central channel 91 extending between a lower opening 93 and an upper opening 95, and surrounded by inner surface 85. Inner sleeve 73 includes a top end 97, a bottom end 99, an outer surface 101, and an inner surface 103. Inner sleeve 73 defines a plurality of adjustment holes 105, a pair of bracket holes 107, a central channel 109 extending between a lower opening 111 and an upper opening 113, and surrounded by inner surface 103.

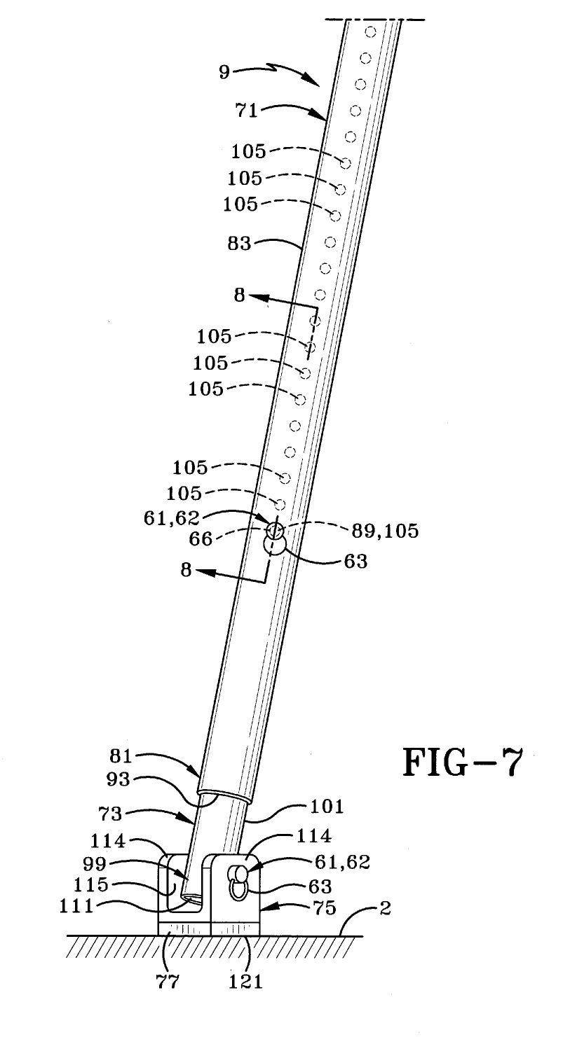

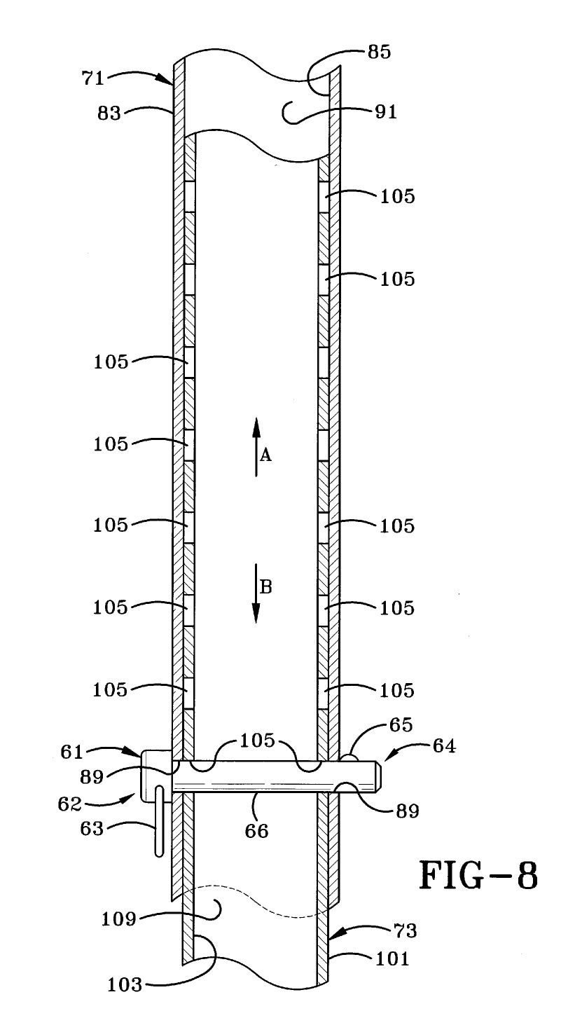

Leg assembly 9 is formed and assembled in the following manner. As shown in FIGS. 7 and 8, outer sleeve 71 is sized to receive inner sleeve 73 slidably therein. Top end 97 of inner sleeve 73 is inserted into bottom end 81 of outer sleeve 71 by way of lower opening 93 in outer sleeve 71. Thereafter, a desired length of inner sleeve 73 is slidably inserted into central channel 91. As shown in FIG. 8, outer surface 101 of inner sleeve 73 slides along inner surface 85 of outer sleeve 71. The overall cross-sectional shape of inner sleeve 73 is sized to precisely fit into outer sleeve 71 with only a fractional gap therebetween, thus lateral movement is effectively eliminated. Once inner sleeve 73 is inserted into outer sleeve 71, the user determines the overall desired length of leg assembly 9 and positions inner sleeve 73 and outer sleeve 71 relative one another to realize the overall desired length. As shown in FIGS. 7 and 8, adjustment holes 105 are disposed along the length of inner sleeve 73, and are sized and positioned to align with lower pin holes 89 of outer sleeve 71. It will be readily understood that adjustment holes 105 of inner sleeve 73 are spaced apart to allow the user to select which adjustment holes 105 most closely correspond with the desired height of leg assembly 9. As shown in FIG. 8, one of the plurality of cotter pins 61 is inserted through one of lower pin holes 89, into one of adjustment holes 105, through central channel 109, out another one of adjustment holes 105, and out the other one of lower pin holes 89. Thus, further movement of inner sleeve 73 within outer sleeve 71 in the directions of Arrow A or Arrow B is prevented, thereby fixing leg assembly 9 at the desired length.

As shown in FIGS. 4-6 and 9, after leg assembly 9 is assembled, top end 79 of outer sleeve 71 is configured to be removably secured to angled bracket 5. As shown in FIG. 4, leg recess 43 is sized and shaped to complementarily receive top end 79 therein. The user inserts top end 79 into opening 46 and applies pressure on leg assembly 9 to slide outer surface 83 of outer sleeve 71 on surface 44 of leg recess 43, thereby moving top end 79 as far into recess 43 as possible. Due to the tight fitting nature between outer sleeve 71 and recess 43, air is expelled through opening 52 of air channel 51, thereby allowing outer sleeve 71 to move farther into recess 43 without trapping air therebetween. Air channel 51 makes insertion and removal of outer sleeve 71 easier, as air can move freely as needed through air channel 51. After outer sleeve 71 is fully inserted into recess 43, outer sleeve 71 is manually axially rotated within recess 43 to align upper pin holes 87 with pin shaft 55. Thereafter, one of the plurality of cotter pins 61 is inserted through first opening 57 into pin shaft 55. As shown in FIG. 9, cotter pin 61 is then pressed through outer sleeve 71 by way of upper pin holes 87, and out of pin shaft 55 through second opening 59, having shaft 66 disposed therein. After cotter pin 61 is fully inserted through angled bracket 5 and outer sleeve 71, top end 79 of outer sleeve 71 is thereby releasably secured to angled bracket 5. When a user wishes to remove outer sleeve from recess 43, cotter pin 61 is simply pulled out of upper pin holes 87 and pin shaft 55, thereby releasing outer sleeve 71 from angled bracket 5.

As shown in FIGS. 2 and 7, foot bracket 75 is a U-shaped member having a pair of sidewalls 114, a bottom wall 117, and an inner channel 115 disposed therebetween. Each sidewall 114 defines a pin aperture 118 (FIG. 2) therethrough. Inner channel 115 is sized to receive bottom end 99 of inner sleeve 73 therein, whereby 61 (FIG. 7) is inserted through one of sidewalls 114, through bracket holes 107 of inner sleeve 73, and through the other one of sidewalls 114. Thus, cotter pin 61 forms an axis, whereby foot bracket 75 may pivot about this axis with respect to inner sleeve 73. Bracket base 77 is fixed on bracket 75 and provides a brace surface 121 for gripping and abutting surface 2.

As seen in FIG. 1, leg assemblies 9 extend outwardly away from beam 3 at Angle M when viewed from the direction of FIG. 1. This angle is generally greater than 90 degrees, such that beam 3 is sufficiently braced against downward force towards surface 2. Likewise, as seen in FIG. 3, leg assemblies 9 extend outwardly away from beam 3 at Angle N when viewed from the direction of FIG. 3. Angle N is configured to space foot brackets 75 horizontally outwardly away from beam 3. Thus, this angle is in the range of 10 to 20 degrees, which helps to brace beam 3 against downward force towards surface 2. Also seen in FIG. 3, Angle 0 is a complementary angle to Angle N, and orients leg assemblies 9 in a non-perpendicular angle with surface 2, adding stability to portable lift 1.

The longitudinal axis of leg assemblies 9 and the horizontal plane of surface 2 meet at foot brackets 75, whereby cotter pin 61 accounts for this change in angle by allowing inner sleeve 73 and foot bracket 75 to complementarily pivot about shaft 66 of cotter pin 61. As shown in FIGS. 1, 3, and 7, bottom end 99 of inner sleeve 73 fits into inner channel 115 of foot bracket 75. Inner sleeve 73 extends from outer sleeve 71, which is secured to angled bracket 5 when portable lift 1 is in the assembled position. Inasmuch as leg assembly 9 support beam 3 through angled bracket 5, foot bracket 73 must compensate for the angled nature of inner sleeve 73 to provide a stable intersection between leg assembly 9 and surface 2. Foot bracket 73 provides an angled connection point for inner sleeve 73 through pin apertures 118 and cotter pin 61, while further providing a flat planar connection point for surface 2 through bracket base 77. Inner sleeve 73 is received and secured to sidewalls 114 through cotter pin 61, such that cotter pin 61 enters one of the pin apertures 118, extends through bracket holes 107 in bottom end 99 of inner sleeve 73, and out the other one of the pine apertures 118. Bottom end 99 and foot bracket 75 are free to rotate around the axis of cotter pin 61 to position foot bracket 75 such that bottom end 99 is received at the appropriate angle by inner channel 115, and the plane of surface 2 is met by brace surface 121 of bracket base 77. Thus, a continuous and stable connection is provided between surface 2 and leg assembly 9 by way of foot bracket 75.

As shown in FIGS. 2, 9, and 10, lift assembly 7 includes a trolley arm 123 having a first end 125, a second end 127, a first side 126, and a second side 128. Lift assembly 7 further includes a plurality of wheels 129, separated into a first set of wheels 129A, a second set of wheels 129B. First set of wheels 129A are rollably connected to trolley arm 123 proximate first end 125 on first side 126, and second set of wheels 129B are rollably connected to trolley arm 123 proximate first end 125 on second side 128. Lift assembly 7 further includes a motor housing 131 containing a motor (not shown). As shown in FIGS. 9 and 10, motor housing 131 receives second end 127 of trolley arm 123 therein, with first end 125 of trolley arm 123 and wheels 129 extending outwardly away therefrom. The motor within motor housing 131 is used to mechanically retract and release a lift strap 133 extending therefrom in response to user commands entered through a user interface (not shown).

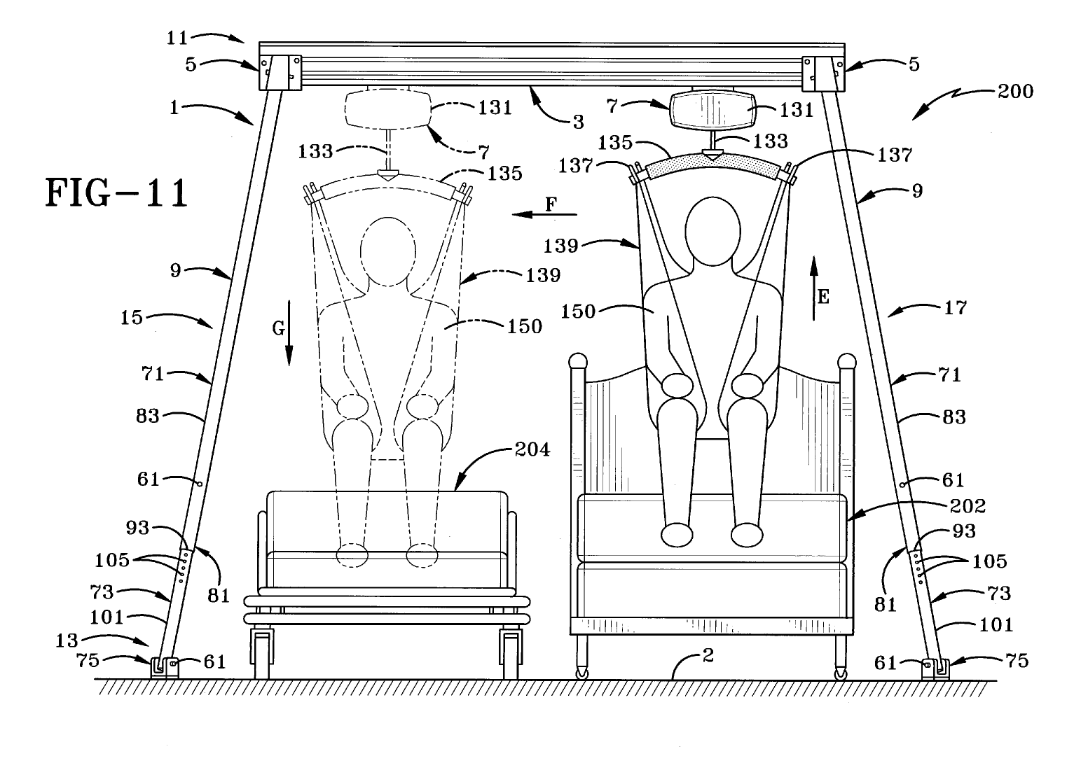

Lift strap 133 is attached to a carry bar 135, and may be selectively releasable or interchangeable with another style carry bar for use in different applications, such as a morgue, operating room, or bariatric situations. Carry bar 135 includes two spaced apart hooks 137 which provide attachment points for a sling 139 (FIG. 11). Carry bar 135 may also be integrated with lift strap 133 such that these elements are not separable. A weight scale (not shown) may be included along with the lift strap 133 or carry bar 135 such that a transferee can be weighed during a transfer, thereby eliminating unnecessary additional steps. When the transferee is lifted in sling 139, the weight scale delivers a reading based on the amount of downward force on the carry bar 135. This information can be critical in accessing whether devices farther down the line of the response can hold the weight of the individual. For example, when an individual is being lifted, if the weight scale indicates that the individual exceeds the weight limit of the waiting stretcher or ambulance, new measures must be taken to deal with this individual.

As shown in FIGS. 9 and 10, lift assembly 7 may be selectively coupled to beam 3 by inserting first end 125 of trolley arm 123 into track 23. First end 125 is inserted into track 23 through track openings 25 at either first end 19 or second end 21. As shown in FIG. 9, wheels 129 roll along track surface 31 within track 23 while second end 127 of trolley arm 123 slides along trolley seam 27. Thus, track 23 and seam 27 act in concert to guide wheels 129 and trolley arm 123 along track 23 from first end 19 to second end 21 in the directions of Arrow C and Arrow D, shown in FIG. 10. While first end 125 is inside track 23, movement of lift assembly 7 in the vertical direction is prevented by bottom wall 26 and the general downward gravitational force exerted on lift assembly 7. Likewise, movement in any horizontal direction which is not parallel with the longitudinal alignment of track 23 is prevented by sidewalls 22 and the abutment of trolley arm 123 and trolley seam 27.

Each of the elements in portable lift 1 are tested, rated, and verified for supporting a particular weight limit. Thus, in the fully assembled state, portable lift 1 has an overall weight limit which it has been thoroughly tested and verified to support. The overall weight limit for portable lift 1 is approximately 3,000 pounds. Likewise, lift assembly 7 is supplied with a sufficient internal motor and gears to accommodate lifting an individual weighing less than this limit. As such, the user of portable lift 1 can be assured that any bariatric individual requiring lifting can be serviced by portable lift 1. This weight limit represents another efficiency of portable lift 1 in that the emergency response personnel do not have to bother determining whether the individual can be supported by portable lift 1, as 3,000 pounds is much greater than the heaviest human being recorded to date at 1,400 pounds. As such, emergency personnel can quickly work on getting the individual into the sling and setting up portable lift 1, instead of contemplating whether the portable lift 1 will hold the unknown weight of the individual.

Referring now particularly to FIG. 11, portable lift 1 is shown in the assembled stated resting on surface 2 and facilitating the transportation of a patient 150 from a bed 202 to a wheeled apparatus 204, shown as an ambulance stretcher. As seen in FIG. 11, patient 150 is secured to carry bar 135 by way of sling 139 and moved out of bed 202 upwards in the direction of Arrow E by the retraction of lift strap 133 by lift assembly 7. Lift assembly 7 is then moved along beam 3 in the direction of Arrow F so that patient 150 is positioned vertically above stretcher 204. Patient 150 is then lowered in the direction of Arrow G by way of lift assembly extending lift strap 133 to lower patient 150 into stretcher 204. In this way, portable lift 1 facilitates the movement of patient 150 in a mechanical manner which is safe to patient 150 and any medical personnel assisting with the movement. It will be readily understood that portable lift 1 is assembled and positioned as desired to best facilitate the movement of patient 150 and assist emergency medical personal. As shown in FIG. 11, portable lift 1 is positioned in such a manner to locate back end 17 such that lift assembly 7 is directly vertically over bed 202, and to locate front end 15 proximate stretcher 204 such that lift assembly 7 is vertically above stretcher 204. Surface 2 is generally horizontally flat, thus requiring all four individual leg assemblies 9 to be set at the same general height. As such, FIG. 11 shows a method of use 200 for a flat horizontal surface 2.

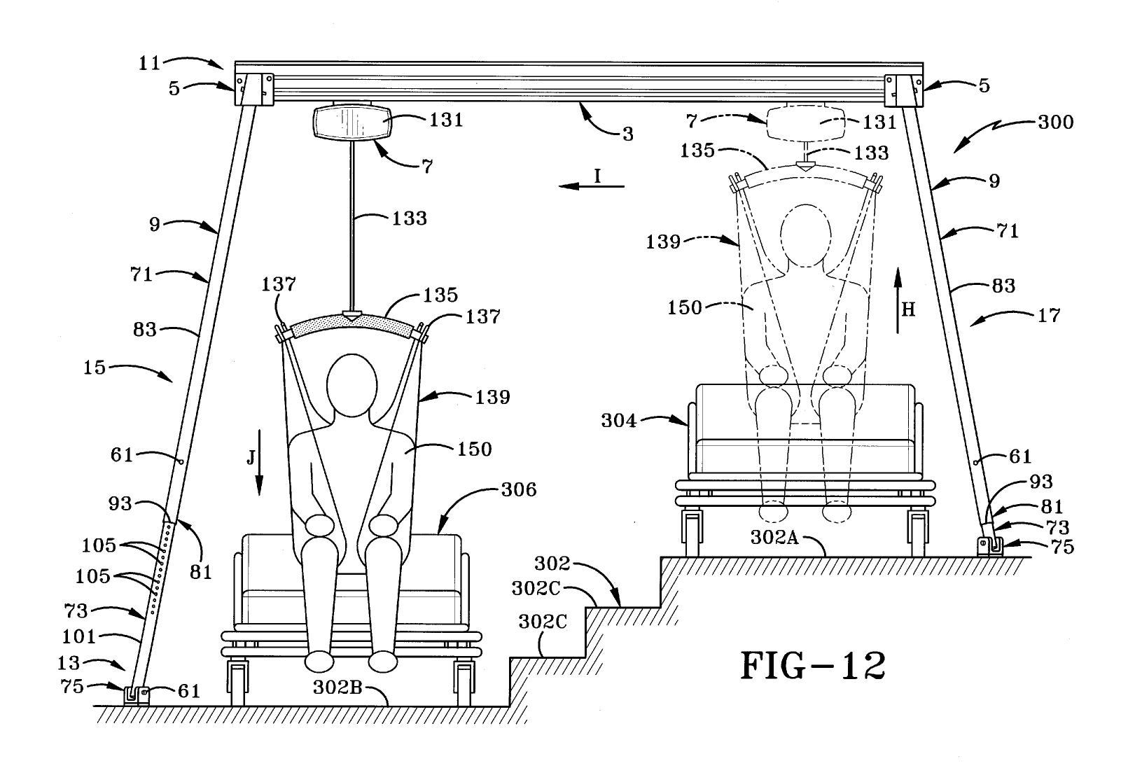

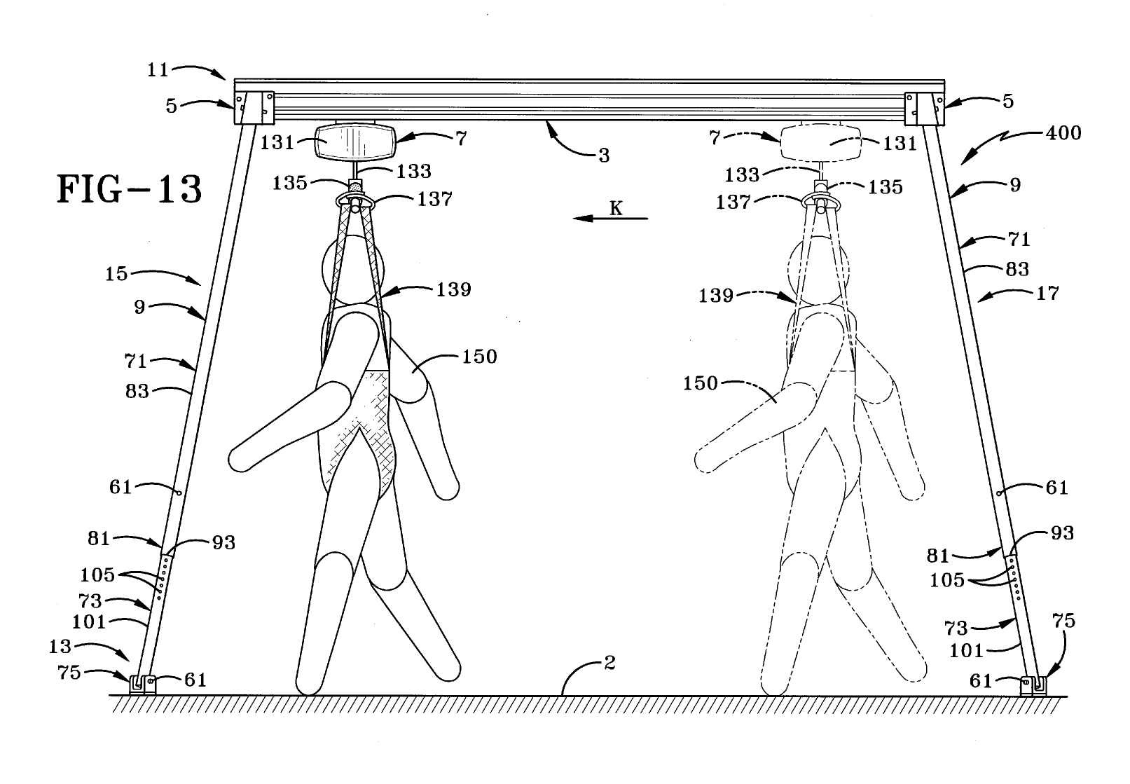

FIG. 12 shows a method of use 300 for using portable lift 1 on an uneven surface 302, such as found in most home settings where steps 302C are used to move from one horizontal level 302A to another horizontal level 302B within the home. While a wheeled apparatus such as stretcher 204 may be manually moved down steps 302C, it is only with great effort by emergency medical personnel that this may be achieved. Furthermore, there is tremendous risk to patient 150 in that manually moving patient 150 in stretcher 204 over steps 302C may affect the balance of stretcher 204 and may cause patient 150 to roll off stretcher 204 and onto surface 302.

Method 300 is generally used in conjunction with method 200 after patient 150 has been removed from bed 202 and placed into stretcher 204. As patient 150 is moved along in stretcher 204, steps 302C may be encountered or some other obstacle which is not conducive for continued rolling of patient 150 in stretcher 204. When this occurs, portable lift 1 is configured to allow the lifting of patient 150 out of stretcher 204 in the direction of Arrow H. Next, the patient is moved along beam 3 by way of lift assembly 7 in the direction of Arrow I. Finally, lift assembly 7 is vertically above either another stretcher such as a stretcher 206, or the medical personnel may move the same stretcher 204 down to the lower level and position it vertically below lift assembly 7. Patient 150 is then lowered onto stretcher 204, 206. Thus, patient 150 is moved in a controlled mechanical manner from surface 302A over steps 302C and onto surface 302B where further movement along surface 302B by way of stretcher 204, 206 may be manually facilitated.

It is one of the primary features of portable lift 1 that leg assemblies 9 are individually configurable to extend to meet surfaces which exist in different horizontal planes. As seen in FIG. 12, leg assemblies 9A proximate back end 17 of portable lift 1 extend from beam 3 to meet surface 302A. Conversely, leg assemblies 9B proximate front end 15 of portable lift 1 extend a much greater length to ensure that leg assemblies 9B meet surface 302B. Thus, the extremely difficult maneuver of moving patient 150 from upper surface 302A to lower surface 302B over steps 302C is thereby achieved by adjusting leg assemblies 9. Leg assemblies 9A meet surface 302A and leg assemblies 9B meet surface 302B which results in beam 3 maintaining a parallel spaced relationship with both surface 302A and 302B such that the lip assembly 7 travels in a horizontal plane. Furthermore, inasmuch as portable lift 1 includes four separate leg assemblies 9, each leg assembly 9 is adjustable to meet a corresponding surface. Thus, if patient 150 must be transported over a terrain which includes four separate and distinct horizontal surfaces, portable lift 1 may be configured to correspond to this varied terrain, by way of individually adjusting each leg assembly 9 to meet each horizontal surface.

As shown in FIG. 13, a method of use 400 is shown whereby a patient 150 may conduct rehabilitation exercises using portable lift 1. The modular nature of portable lift 1 is such that method 400 may be performed outside of a hospital or rehabilitation clinic setting, including the home of patient 150. It is contemplated that portable lift 1 may be transported and assembled in the home of patient 150 to facilitate rehabilitation exercises. Method 400 eliminates the need for transporting patient 150 to a hospital or rehabilitation clinic given that transportation and movement in general would necessarily be impeded by the condition of patient 150. It will be readily understood that if patient 150 requires movement exercises for rehabilitation, movement from the house of patient 150 to a hospital would necessarily be extremely difficult. Therefore, portable lift 1 is transported to the house of patient 150 and assembled so that patient 150 may conduct the exercises with minimal additional transportation. Thus, an entirely new service is provided by portable lift 1 in that home rehabilitation services may be offered and conducted as desired. It is contemplated that portable lift 1 may also be used in war zones, or geographically hard to reach areas, or areas which have been affected by a natural disaster. Naturally, rehabilitation clinics may be a great distance from these areas. The modular nature of portable lift 1 facilitates transportation to these areas, whereby portable lift 1 may be assembled to provide rehabilitation services to individuals in need.

As shown in FIG. 13, the rehabilitation exercise generally includes a walking motion whereby sling 139 holds patient 150 in an upright walking position and provides both safety and weight reducing benefits to the user. If the patient stumbles or experiences muscle fatigue, the entire weight of patient 150 may be supported by portable lift 1. Additionally, lift strap 133 and sling 139 may be configured such that the overall body weight of patient 150 is reduced. Thus, patient 150 may conduct rehabilitation exercises while having a reduced body weight, which will be readily understood to be beneficial during the rehabilitation process. Thus, portable lift 1 offers numerous benefits over conventional style ceiling mounted tracks for rehabilitation.

In operation, portable lift 1 is transported in a fully disassembled state, as shown in FIG. 2. In this state, all elements are separated and may be placed into an easy to carry container such as a large duffel bag. It is envisioned that portable lift 1 will be transported on any relevant emergency medical calls to the home of patient 150. As such, all individual pieces that comprise portable lift 1 are generally sized to fit within a typical ambulance vehicle or fire emergency response vehicle. Once emergency medical personnel receive a call or notification of an emergency involving a generally immobile bariatric individual, the vehicle is dispatched with portable lift 1 in the fully disassembled state contained therein. Once arriving at the emergency location, one of the emergency medical personnel carries the duffel bag containing the individual pieces of portable lift 1 into the household or building containing the individual requiring medical attention. For ease of illustration, the emergency medical situation discussed henceforth will be one of a bariatric individual weighing several hundred pounds requiring an emergency medical transportation from this individual's house to a hospital. In this scenario, the emergency medical personnel arrive at the scene and carry the portable lift 1 in the fully disassembled state into the home of patient 150. Portable lift 1 is then moved to the fully assembled state over patient 150's bed, as shown in FIG. 11. Namely, leg assemblies 9 are adjusted to the appropriate height by way of outer sleeve 71 and inner sleeve 73 being connected by one of cotter pins 61 at the appropriate height. Each top end 79 of each outer sleeve 71 is then inserted into leg receivers 41 of angled brackets 5, and thereby secured therein by one of cotter pins 61. Lift assembly 7 is then slidably inserted into track 23 of beam 3. Finally, angled brackets 5 are secured onto beam 3, by one of cotter pins 61. Foot brackets 75 are thereby secured to bottom end 99 of each inner sleeve 73 by one of cotter pins 61 such that bracket base 77 rests on surface 2.

As shown in FIG. 11, surface 2 is generally an elongated flat horizontal surface with no disruptions or vertical changes. It will be understood that portable lift 1 may be assembled by a single individual acting as an emergency response individual. Furthermore, the assembly of portable lift 1 is efficiently streamlined by the use of the plurality of cotter pins 61, having a generally uniform shape and used interchangeably throughout the connection points of portable lift 1. As such, the emergency response personnel may simply grab any one of the plurality of cotter pins 61 when a connection is required and insert that cotter pin 61 to achieve the connection. Furthermore, when disassembly of portable lift 1 is required, inasmuch as cotter pins 61 are all the same size and shape, cotter pin 61 may be removed and placed into whatever container is desired, without any afterthought for organizing individual cotter pins 61. Typically emergency situations require very efficient use of time to move the individual from a house to a hospital, therefore, time is of the essence in most situations involving emergencies and requiring portable lift 1. When the individual disassembles portable lift 1, each cotter pin 61 may be simply removed and placed into a container for later use. This concept achieves enormous time efficiencies over related devices in that different connection points require different types of connection pins, screws, or fasteners. It will be readily understood that these fasteners, being all different, may require a larger amount of time to look at and consider when a particular fastener shape is required.

Once portable lift 1 is in the fully assembled state, patient 150 is transported from bed 202 onto stretcher 204, as described above. Patient 150 is then manually transported along surface 2 wherein either surface 2 leads directly to the emergency vehicle, or surface 2 encounters a disruption requiring the additional use of portable lift 1. In the case of a flat surface 2 leading directly to the emergency vehicle, patient 150 is manually wheeled directly to the emergency vehicle and loaded into the bay as typically done in any emergency response situation. In the event that a disruption of surface 2 is encountered, portable lift 1 is disassembled as needed and moved to facilitate moving patient 150 over this disruption. As shown in FIG. 12, portable lift 1 has been reconfigured from that shown in FIG. 11 to elongate leg assemblies 9B such that a stable connection is achieved between beam 3 and surface 302B. Furthermore, leg assemblies 9A have been retracted to shorten the overall length of leg assemblies 9A and provide a stabile connection between beam 3 and surface 302A. It can be readily understood that this vertically aligns beam 3 with surfaces 302A and 302B such that patient 150 may be lifted off stretcher 204, transferred along beam 3, and then lowered back down onto stretcher 204 or an additional stretcher 206 on surface 302B. Thus, the vertical disruption shown as 302C is bypassed by portable lift 1 without requiring any lifting by the emergency response personnel.

Finally, patient 150 is transported from surface 302B directly to the emergency response vehicle and loaded therein. As a result, the emergency response personnel do not have to lift a bariatric patient in any way other than to secure sling 139 to patient 150. Thus, the safety and health of emergency response personnel is protected while maintaining a fast and efficient extraction of patient 150 from their home. Once patient 150 is loaded into the emergency response vehicle, the emergency response personnel quickly disassemble portable lift 1 and move it from a fully assembled state to a fully disassembled state. The individual elements comprising portable lift 1 are thereby loaded into the carrying device and stowed back in the emergency response vehicle. This can be done in an extremely efficient and quick manner by simply pulling all cotter pins 61, removing leg assemblies 9 from angled brackets 5, and removing angled brackets 5 from beam 3.

As described in the foregoing, portable lift 1 provides an efficient and novel manner for moving patients, primarily of a bariatric-nature, from one area to another. The portable nature of lift 1 allows medical response personnel to easily transport lift 1 to any situation where a lift is required. Portable lift 1 is specifically adapted to be quickly assembled by one or two people for use in emergency situations. The overall size of each individual element of portable lift 1 is purposely configured to allow for the transportation of portable lift 1 in the bay of ambulances and emergency fire vehicles. Thus, it is intended that portable lift 1 will be quickly and easily adopted into industry standard response procedures for dealing with a bariatric emergency situation.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A portable lift comprising:
a beam;
a lift assembly removably engageable with the beam;
a plurality of legs removably engageable with the beam to support the beam; and
wherein the legs support greater than 500 pounds of weight applied to the beam.

2. The portable lift of claim 1, wherein each of the plurality of legs includes an individually adjustable length.

3. The portable lift of claim 2, further comprising a first bracket removably connectable with a first end of the beam and a second bracket removably connectable with a second end of the beam, and wherein at least a first pair of the plurality of legs is removably connectable with the first bracket and at least a second pair of the plurality of legs is removably connectable with the second bracket.

4. The portable lift of claim 3, wherein each of the plurality of legs includes an inner sleeve and an outer sleeve slidable thereon to adjust the length.

5. The portable lift of claim 4, further comprising a cotter pin associated with a first leg in the plurality of legs, wherein the cotter pin removably extends through the inner sleeve and outer sleeve of the first leg to thereby adjustably hold the first leg at the length.

6. A portable lift comprising:
a beam defining a track and having a first end and a spaced apart second end;
a first bracket secured to the first end of the beam;
a second bracket secured to the second end of the beam;
a plurality of leg assemblies, wherein each leg assembly includes an individually adjustable longitudinal length, and wherein each leg assembly is removably secured to one of the first bracket and second bracket; and
a lift assembly having a motorized lift assembly and a trolley portion configured to removably connect to the track.

7. The portable lift of claim 6, wherein each leg assembly includes an outer sleeve, an inner sleeve slidable within the outer sleeve, and a cotter pin, wherein the cotter pin is removably extendable through the outer sleeve and inner sleeve to adjustably hold the leg assembly at the longitudinal length.

8. The portable lift of claim 7, further comprising a first pair of leg recesses defined by the first bracket, wherein each leg recess is sized to receive the outer sleeve of one of the leg assemblies.

9. The portable lift of claim 8, wherein each leg assembly further includes a foot bracket removably connectable to the inner sleeve.

10. The portable lift of claim 8, wherein each leg recess in the first pair of recesses is angled to extend the associated leg assembly received therein away from the other leg assembly as the leg assemblies extend away from the first bracket.

11. A method of transporting an individual from a first location to a second location over a surface, the method comprising the steps of:
locating a first end of a beam proximate the individual and the first location;
supporting the first end of the beam with a first pair of legs having a length;
engaging a lift assembly with the beam;
locating a second end of the beam at the second location;
supporting the second end of the beam with a second pair of legs having a length;
lifting the individual with the lift assembly;
moving the lift assembly and individual along the beam from the first end to the second end over the surface; and
releasing the individual from the lift assembly at the second location.

12. The method of claim 11, further comprising the step of adjusting the length of the first pair of legs.

13. The method of claim 12, further comprising the steps of:
removing a cotter pin from an engagement with an outer sleeve and an inner sleeve of a one of the first pair of legs;
extending the inner sleeve to increase the length of the one of the first pair of legs; and
engaging the cotter pin with the outer sleeve and the inner sleeve to lock the one of the first pair of legs at the length.

14. The method of claim 11, further comprising the step of adjusting the length of the first pair of legs and adjusting the length of the second pair of legs to orient the beam generally horizontally between the first position and the second position.

15. The method of claim 14, wherein the length of the first pair of legs is different than the length of the second pair of legs.

16. The method of claim 14, wherein the surface includes one of a sloped or stepped feature.

17. The method of claim 11, further comprising the steps of:
removably connecting a first bracket onto the first end of the beam;
removably connecting the first pair of legs to the bracket;
removably connecting a second bracket to the second end of the beam; and
removably connecting the second pair of legs to the bracket.

18. The method of claim 11, further comprising the steps of:
disconnecting the lift assembly from the beam;
disconnecting the first pair of legs and the second pair of legs from the beam;
storing the lift assembly, first pair of legs, second pair of legs, and beam in a storage apparatus; and
transporting the storage apparatus to a new location.

19. The method of claim 18, further comprising the step of transporting the storage apparatus to a new location via one of an ambulance and emergency vehicle.

20. The method of claim 11, wherein the individual weighs at least 500 pounds.
